(19) United States
(12) Patent Application Publication
(10) Pub. No.: US 2023/0112153 A1
(43) Pub. Date: Apr. 13, 2023

(54) COAXIAL CABLE ADAPTER FOR DISTRIBUTING A COMPOSITE ETHERNET/POWER SIGNAL TO POWER OVER ETHERNET DEVICES

(71) Applicant: PPC BROADBAND, INC., East Syracuse, NY (US)

(72) Inventors: David A. Barany, Syracuse, NY (US); Thomas Hart, Fayetteville, NY (US)

(21) Appl. No.: 17/965,512

(22) Filed: Oct. 13, 2022

Related U.S. Application Data
(60) Provisional application No. 63/255,260, filed on Oct. 13, 2021.

(51) Int. Cl. H04L 12/10

(52) U.S. Cl. CPC H04L 12/10

(57) ABSTRACT

An Ethernet Power over Ethernet (“PoE”) device provides a composite Ethernet/Power signal to a PoE device regardless of Ethernet connection availability to the PoE device. The device includes a composite Ethernet/Power signal generator configured to receive an Ethernet signal from a source and to receive a DC power signal, generate a composite Ethernet/DC power signal based on the received Ethernet signal and the DC power signal, and output the composite Ethernet/DC power signal to an Ethernet output port such that the composite Ethernet/DC power signal is output to a PoE device over an Ethernet cable regardless of Ethernet connection availability to the PoE device, wherein the DC power signal is configured to power the PoE device.

### CROSS-REFERENCE TO RELATED APPLICATION

This application claims priority to U.S. Provisional Patent Application No. 63/255,260, filed on Oct. 13, 2021, the disclosure of which is incorporated herein by reference in its entirety.

### BACKGROUND

Power over Ethernet (“PoE”) devices have been developed, such as security cameras, VoIP phones, WLAN transmitters, wireless access points, WIFI hotspots, etc. In a conventional PoE device, power and data signals are transmitted over Ethernet twisted pair cabling, such as CAT-5 cabling, to the PoE device. The Ethernet cabling can transmit the data signals and DC power over the Ethernet cabling because the DC common mode voltage does not affect the data signals. In this way, the need to provide any external power directly to the PoE device can be eliminated. Providing power over the Ethernet cable allows the PoE device to be powered by connecting only the Ethernet cabling, so that the PoE device can be disposed at a location where a power outlet is not available.

However, many locations are wired with coaxial cabling and not Ethernet cabling. For example, a location may have been prewired with coaxial wall jacks with coaxial wiring connecting to the coaxial wall jacks, but not have Ethernet wall jacks connected with Ethernet wiring. Accordingly, it would be beneficial if PoE devices configured to accept Ethernet signals at an Ethernet input could be provided power and Ethernet signals over the existing coaxial cabling because this would avoid the need to install separate Ethernet wiring. Instead, existing coaxial wiring could be used to provide Ethernet signals and power to PoE devices using the existing coaxial wall jacks and coaxial cabling.

### SUMMARY

A system is configured to provide composite Ethernet/DC power signal to a PoE (Power over Ethernet) device regardless of Ethernet connection availability. The system may include a network port terminal device that includes a terminal Ethernet input port configured to receive an Ethernet signal, and a terminal coaxial cable output port configured to output the Ethernet signal, a splitter device configured to receive a DC power signal and output the DC power signal to a coaxial cable output port, an Ethernet PoE device that includes a composite Ethernet/DC power signal generator configured to receive the Ethernet signal and to receive the DC power signal at a coaxial cable input port, generate a composite Ethernet/DC power signal based on the received Ethernet signal and the DC power signal, and output the composite Ethernet/DC power signal to an Ethernet output port, wherein the network port terminal device further comprises an RF input port for receiving an RF input signal, wherein the RF input signal is a cable TV (CATV) signal, wherein the network port terminal device outputs the RF signal to the splitter device, and wherein the composite Ethernet/DC power signal includes the RF signal, wherein the splitter device includes a splitter coaxial cable output port that is configured to output the composite Ethernet/DC power signal based on the received Ethernet signal and the received DC power signal to a coaxial cable, wherein the PoE Ethernet output port of the Ethernet PoE device is configured to output the composite Ethernet/DC power signal to a PoE device through an Ethernet cable regardless of whether the PoE device is located where an Ethernet connection is available, and wherein the DC power signal is configured to power the PoE device.

A system is configured to provide a composite Ethernet/DC power signal to a PoE (Power over Ethernet) device regardless of Ethernet connection availability. The system includes a splitter device configured to receive a DC power signal and output the DC power signal to a coaxial cable output port, an Ethernet PoE device that includes a composite Ethernet/DC power signal generator configured to receive an Ethernet signal from a source and to receive a DC power signal at a coaxial cable input port, generate a composite Ethernet/DC power signal based on the received Ethernet signal and the DC power signal, and output the composite Ethernet/DC power signal to an Ethernet output port, wherein the coaxial cable output port of the splitter device is configured to output the DC power signal over a coaxial cable to the Ethernet PoE device, wherein the Ethernet PoE device is configured to output the composite Ethernet/DC power signal to the PoE device through an Ethernet cable connected to the Ethernet output port regardless of Ethernet connection availability to the PoE device, and wherein the DC power signal is configured to power the PoE device.

A coaxial to Ethernet PoE adapter device is configured to provide a composite Ethernet/DC power signal to a PoE device regardless of Ethernet connection availability. The coaxial to Ethernet PoE adapter device may include a composite Ethernet/DC power signal generator configured to receive an Ethernet signal from a source and to receive a DC power signal at a coaxial cable input port, generate a composite Ethernet/DC power signal based on the received Ethernet signal and the DC power signal, and output the composite Ethernet/DC power signal to an Ethernet output port, wherein Ethernet PoE device is configured to output the composite Ethernet/DC power signal to the PoE device through an Ethernet cable connected to the Ethernet output port regardless of Ethernet connection availability to the PoE device, and wherein the DC power signal is configured to power the PoE device.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings.

FIG. 1 illustrates a schematic view of a Ethernet PoE device configured to receive power and Ethernet signals over coax and to output power and Ethernet signals over an Ethernet cable to a PoE device according to an embodiment.

FIG. 2 illustrates a schematic view of an Ethernet PoE device according to an embodiment.

FIG. 3 illustrates a schematic view of system configured to provide a composite power and Ethernet signal to a PoE device over a coaxial cable according to an embodiment.

FIG. 4 illustrates a schematic view of an alternate system configured to provide a composite power and Ethernet signal to a PoE device according to an embodiment.

### DETAILED DESCRIPTION

The present disclosure relates to a device that is configured to receive Ethernet signals and power over a coaxial cable (alternatively referred to as “coax”) at a coaxial input and to output the Ethernet signals and power over an Ethernet cable to a PoE device. In some embodiments, the device may be configured to receive Ethernet signals, RF signals such as cable tv signals and power at the coaxial input and to output the Ethernet signals and power over an Ethernet cable to a PoE device.

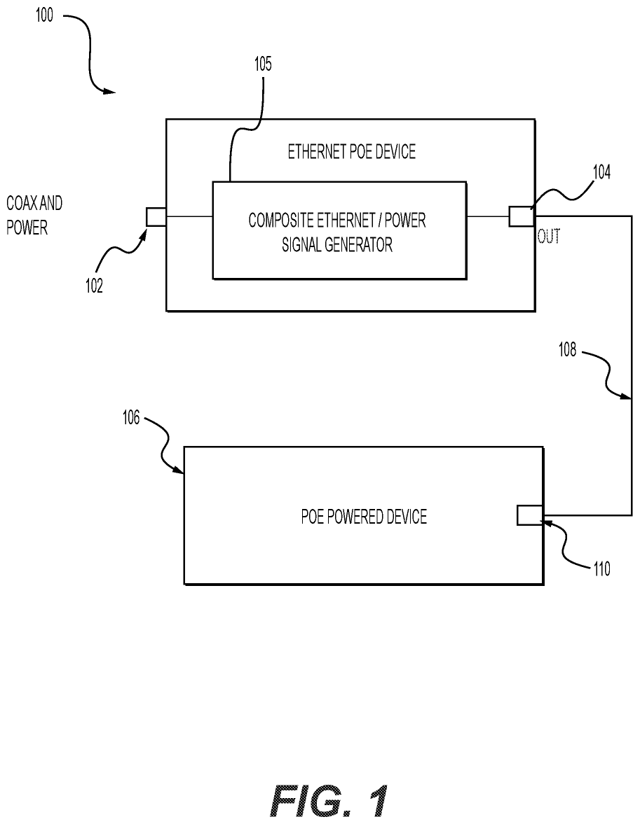

FIG. 1 illustrates a schematic view of an Ethernet PoE device 100 (Ethernet PoE adapter device) according to an embodiment. The Ethernet PoE device 100 has a coaxial input 102 configured to connect to a coaxial cable and an Ethernet output port 104 configured to connect to an Ethernet cable 108. In some embodiments, the coaxial input port 102 is configured to receive a DC power signal. In some embodiments, the coaxial input port 102 is configured to receive a composite signal over the coaxial cable, where the composite signal may comprise an Ethernet signal and a DC power signal. In some embodiments, the composite signal may be an Ethernet signal, a RF signal and a power signal. In embodiments where the coaxial input port 102 receives the DC power signal but not an Ethernet signal, the Ethernet PoE device 100 may include a separate Ethernet input port for receiving an Ethernet signal.

The Ethernet PoE device 100 is configured to provide the DC power signal or the composite signal including the Ethernet signal and DC power to a PoE device 106 over the Ethernet cable 108, which may be connected to the Ethernet input connector 110 of the PoE device 106. The PoE device 106 may be a device such as a security camera, a wireless access point, a WIFI hotspot device, a voice over IP phone, or another device using the IEEE 802.3af/at standard. By providing the Ethernet signals and DC power over the coaxial cable, the PoE device 106 does not need to be connected to a power outlet and does not need to be placed at a location having an Ethernet wall outlet, and thus a user will have more freedom in placement of the PoE device 106.

In some embodiments, the Ethernet PoE device 100 may have a plurality of Ethernet outputs 104 to allow connection to a plurality of PoE devices 106. Additionally, in some embodiments, the PoE device 106 may have a separate output for outputting the RF signals. In some embodiments, the PoE device 106 may include the Ethernet output 104 including the Ethernet signal and power, and may include a separate Ethernet output that outputs the Ethernet signal to a non-PoE device, but does not output power.

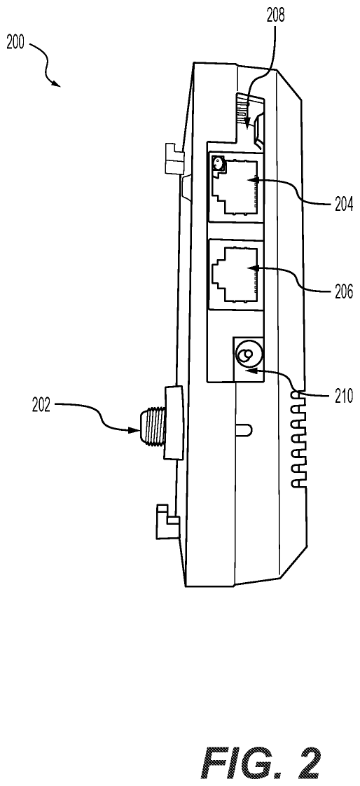

FIG. 2 illustrates a view of an Ethernet PoE device 200 according to an embodiment. The Ethernet PoE device 200 corresponds to the Ethernet PoE device 100. The Ethernet PoE device 200 has a coaxial input 202 configured to receive a DC power signal or a composite Ethernet/DC power signal over a coaxial cable connected to the coaxial input 202. The composite signal may include an Ethernet signal and DC power. In some embodiments, the Ethernet signal may be a 1350-1675 MHz signal, although other frequencies may be utilized, and the DC power may be 40 VDC to 57 VDC. In some embodiments, the composite signal may also include an RF signal, which may be a 5-1218 MHz signal. In embodiments where the composite signal includes the RF signal, an RF coaxial output (not shown in FIG. 2) may be included for connection to an RF device such as a TV, a splitter, a modem, etc.

The Ethernet PoE device 200 has an Ethernet PoE output port 204 configured to connect to an Ethernet cable (not shown). The Ethernet POE output port 204 is configured to deliver Ethernet signals and DC power signals to a PoE device over the Ethernet cable. In some embodiments, the power delivered to the PoE device over the Ethernet cable may be in a range of 40 VDC to 57 VDC and is used to power the PoE device. In some embodiments, the power delivered to the PoE device over the Ethernet cable may be 48 VDC, although other power levels could be used. In some embodiments, the power signal may provide 24 Watts of power, although other power levels could be used. In some embodiments, the Ethernet PoE device 200 may include a plurality of Ethernet output ports to deliver Ethernet signals and DC power to a plurality of PoE devices over Ethernet cables.

The Ethernet PoE device 200 may include an Ethernet output port (or ports) 206 configured to deliver Ethernet signals, but not power. The Ethernet output port 206 is configured to be connected to an Ethernet device, such as a modem.

In some embodiments, the Ethernet signals may be signals within the frequencies of 5-1002 MHz. In some embodiments, the Ethernet signals may be signals within the frequencies of 5-1218 MHz. In some embodiments, the Ethernet signals may be signals within the frequencies of 5-1675 MHz.

The Ethernet PoE device 200 may optionally include a 48 VDC PoE voltage on/off switch 208. The 48 VDC PoE voltage on/off switch 208 allows a user to turn the 48 VDC power supplied on the Ethernet PoE output port 204 on or off.

The Ethernet PoE device 200 may optionally include a 48 VDC local power input port 210. The 48 VDC local power input port 210 allows power to be received locally if power is not available over the coaxial input port 202. If the power is received locally, the Ethernet PoE device 200 may be configured to utilize this power to combine with the Ethernet signals received at the coaxial input port 202 into a composite Ethernet/power signal to supply to the PoE device.

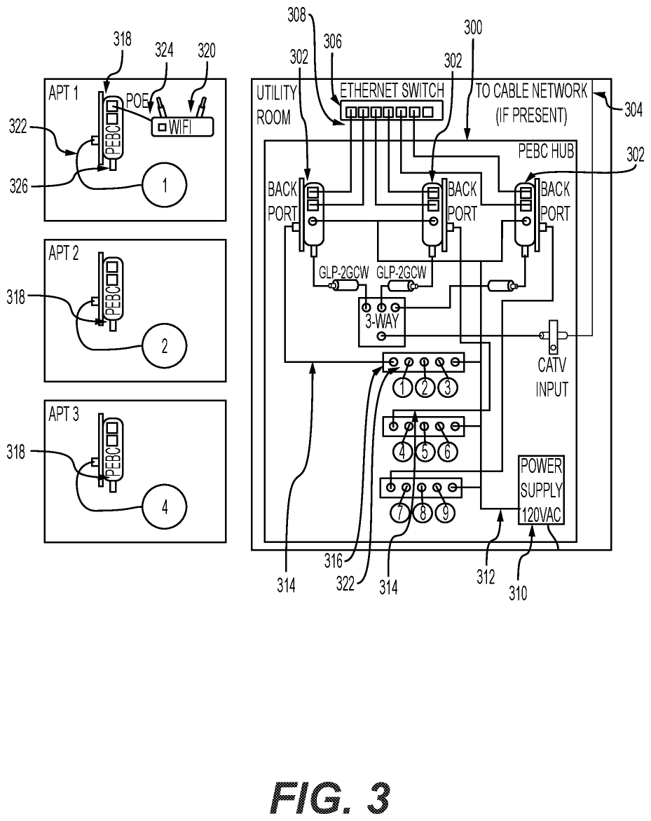

FIG. 3 illustrates a schematic view of a system 300 configured to provide a plurality of composite power and Ethernet signals and DC power over a coaxial cable to one or a plurality of locations. The system 300 includes a plurality of network port terminal devices 302. Each of the network port terminal devices 302 is configured to receive one or a plurality of Ethernet signals from Ethernet switch 306 over Ethernet cables 308 and to receive power from 120 VAC power supply 310 over power lines 312.

The network port terminal devices 302 are configured to provide an Ethernet signal that is sent over coaxial cables 314 to one or more of the splitter devices 316. The splitter devices 316 also receive DC power from the power supply 310 over power lines 312. The splitter devices 316 are configured to generate a composite signal from the Ethernet signal received over coaxial cables 314 and from the power received over power lines 312 and output a plurality of composite Ethernet/DC power signals to each of the dwellings (shown in FIG. 3 as Apt. 1, 2 and 3) over coaxial cables 322. Optionally, the composite signals generated by the network port terminal devices 302 may include an RF signal, such as a cable TV signal, received over lines 304.

Each of the dwellings may have an Ethernet PoE device 318 that receives the composite Ethernet/DC power signal (or Ethernet, RF (cable TV) and power signal) over a coaxial cable 322 at a coaxial input port and outputs the composite Ethernet/DC power signal over an Ethernet cable 324 to the PoE device 320. If an RF cable TV signal is provided, the Ethernet PoE device 318 may optionally include an RF output port 326 for sending the RF signal to a device such as a TV or a modem (not shown).

In FIG. 3, there are two Ethernet cables connecting the Ethernet switch 306 to each of the network port terminal devices 302. Each of the Ethernet cables may be configured to provide a 1 G-byte signal, and two of the Ethernet cables may be used to provide a 2 G-byte signal, although other types of signals may be used. In some embodiments only one Ethernet cable may be connecting each of the network port terminal devices 302 to the Ethernet switch 306, or more than two Ethernet cables could be used to provide a higher or different bandwidth Ethernet signal.

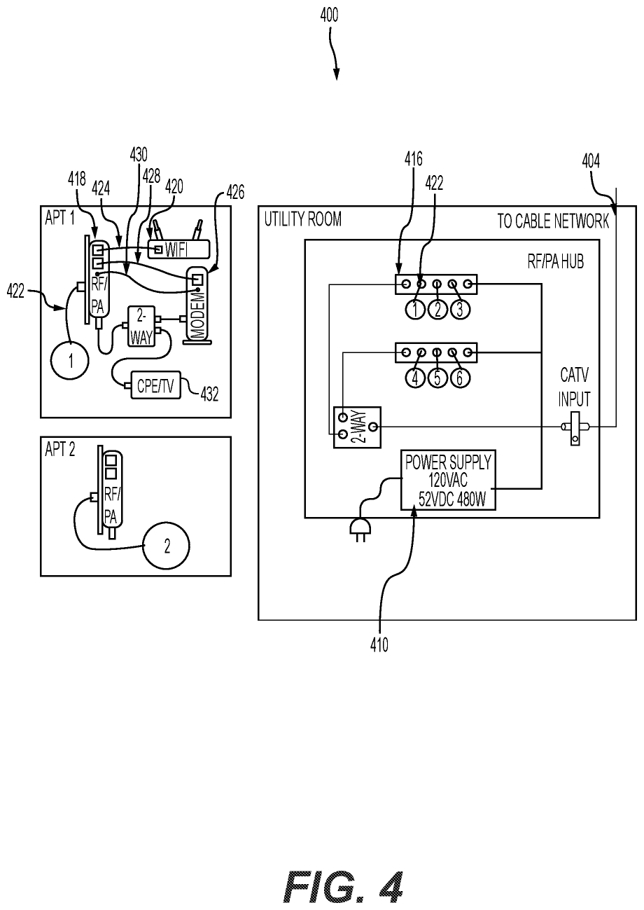

FIG. 4 illustrates an alternate system 400. The system 400 may be configured to receive RF signals, such as CATV signals, over line 404, which are directed to splitter devices 416 along with DC power from power supply 410. The splitter devices 416 may be configured to output composite DC power and RF signals, which are sent to Ethernet PoE device 418 over coaxial cables 422. In some embodiments, the splitter devices may be configured to send DC power, but not RF signals, to the Ethernet PoE device 418. Ethernet signals are received by the Ethernet PoE device 418 from modem 426 over Ethernet cable 428, although the Ethernet signals could be received by a different type of device. Power line 430 supplies 12 VDC power to the modem, although other power levels and/or power sources could be used.

The Ethernet PoE device 418 may be configured to output CATV signals to the RF device (TV) 432 from an RF output port. The Ethernet PoE device 418 outputs Ethernet signals and DC power as a Ethernet/DC power composite signal to the PoE device 420 over Ethernet cable 424. The power supplied to the PoE device 420 may be 48 VDC, although other power levels could be used.

Embodiments disclosed herein provide an Ethernet PoE device that receives a composite Ethernet/DC power signal over a coaxial cable and provides the composite Ethernet/DC power signal to a PoE device over an Ethernet cable. Embodiments disclosed herein also provide an Ethernet PoE device that receives a DC power signal over a coaxial cable and receives an Ethernet signal and provides a composite Ethernet/DC power signal to a PoE device over an Ethernet cable. These embodiments provide the advantage of not requiring power outlets to provide DC power for the PoE device because the DC power is received over the coaxial cables at a coaxial input port and is provided to the PoE device over the Ethernet cable, and not requiring Ethernet wall outputs or power at the location where the PoE device is disposed. This provides a user with greater convenience and flexibility in locating the PoE device and requires less cabling.

Embodiments disclosed herein also provide a system that generates a plurality of composite Ethernet/DC power signals that are provided to locations over coaxial cables and are configured to be provided to PoE devices over Ethernet cabling. This system provides the advantage of being able to utilize existing coaxial wiring and wall outlets in the dwellings to receive the composite Ethernet/DC power signals and to deliver the Ethernet signals to the PoE devices over Ethernet cables.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. The present disclosure is not to be limited in terms of the particular embodiments described in this application, which are intended as illustrations of various aspects. Many modifications and variations can be made without departing from its spirit and scope, as will be apparent to those skilled in the art. Functionally equivalent apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only and is not intended to be limiting. Any of the features disclosed herein in the Ethernet PoE devices 100, 200, 318 and 418 may be used with any of these coax to Ethernet PoE devices.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

What is claimed is:

1. A system for providing a composite Ethernet/DC power signal to a Power over Ethernet (“PoE”) device regardless of Ethernet connection availability, comprising:
a network port terminal device that includes a terminal Ethernet input port configured to receive an Ethernet signal, and a terminal coaxial cable output port configured to output the Ethernet signal;
a splitter device configured to receive a DC power signal and output the DC power signal to a coaxial cable output port;
an Ethernet PoE device that includes a composite Ethernet/DC power signal generator configured to receive the Ethernet signal and to receive the DC power signal at a coaxial cable input port, generate a composite Ethernet/DC power signal based on the received Ethernet signal and the DC power signal, and output the composite Ethernet/DC power signal to an Ethernet output port;
wherein the network port terminal device further comprises an RF input port for receiving an RF input signal, wherein the RF input signal is a cable TV (CATV) signal, wherein the network port terminal device outputs the RF signal to the splitter device, and wherein the composite Ethernet/DC power signal includes the RF signal;
wherein the splitter device includes a splitter coaxial cable output port that is configured to output the composite Ethernet/DC power signal based on the received Ethernet signal and the received DC power signal to a coaxial cable;
wherein the PoE Ethernet output port of the Ethernet PoE device is configured to output the composite Ethernet/DC power signal to a PoE device through an Ethernet cable regardless of whether the PoE device is located where an Ethernet connection is available; and
wherein the DC power signal is configured to power the PoE device.

2. The system of claim 1, wherein the network port terminal device comprises a plurality of network port terminal devices, the splitter device comprises a plurality of splitter devices, and each of the network port terminal devices is configured to output Ethernet signals to a corresponding one of the splitter devices over a corresponding coaxial cable.

3. The system of claim 2, wherein the PoE device comprises a plurality of PoE devices, each of the splitter devices is configured to output the composite Ethernet/DC power signal to a plurality of the PoE devices, and each of the PoE devices is at a different one of a plurality of locations.

4. The system of claim 1, wherein the network port terminal device is configured to receive an RF signal at an RF signal input port, wherein the Ethernet/DC power signal includes the RF signal, and wherein the Ethernet PoE device further comprises an RF output port configured to output the RF signal to an RF device.

5. The system of claim 1, wherein the DC power signal comprises a DC voltage signal between 40 VDC and 57 VDC.

6. The system of claim 1, and wherein the Ethernet PoE device further comprises an Ethernet output port configured to output an Ethernet portion of the composite signal to a non-PoE Ethernet device.

7. The system of claim 1, wherein the network port terminal device further comprises a plurality of Ethernet input ports.

8. The system of claim 1, wherein the DC power signal is configured to power the PoE device so that the PoE device does not have to be connected to a power wall outlet and the Ethernet signal is received by the PoE device so that the PoE device does not have to be connected to an Ethernet wall outlet.

9. The system of claim 1, wherein the Ethernet POE device further comprises a power input for receiving DC power.

10. A system for providing a composite Ethernet/DC power signal to a Power over Ethernet (“PoE”) device regardless of Ethernet connection availability, comprising:
a splitter device configured to receive a DC power signal and output the DC power signal to a coaxial cable output port;
an Ethernet PoE device that includes a composite Ethernet/DC power signal generator configured to receive an Ethernet signal from a source and to receive a DC power signal at a coaxial cable input port, generate a composite Ethernet/DC power signal based on the received Ethernet signal and the DC power signal, and output the composite Ethernet/DC power signal to an Ethernet output port;
wherein the coaxial cable output port of the splitter device is configured to output the DC power signal over a coaxial cable to the Ethernet PoE device;
wherein the Ethernet PoE device is configured to output the composite Ethernet/DC power signal to the PoE device through an Ethernet cable connected to the Ethernet output port regardless of Ethernet connection availability to the PoE device; and
wherein the DC power signal is configured to power the PoE device.

11. The system of claim 10, wherein the splitter device comprises a plurality of splitter devices, the PoE device comprises a plurality of PoE devices, and each of the splitter devices is configured to output the composite Ethernet/DC power signal to a plurality of the PoE devices.

12. The system of claim 10, wherein the DC power signal comprises a DC voltage signal between 40 VDC and 57 VDC.

13. The system of claim 10, wherein the DC power signal is configured to power the PoE device so that the PoE device does not have to be connected to a power wall outlet and the Ethernet signal is received by the PoE device so that the PoE device does not have to be connected to an Ethernet wall outlet.

14. The system of claim 10, wherein the Ethernet POE device further comprises a power input for receiving DC power.

15. The system of claim 10, wherein the Ethernet PoE device further comprises an Ethernet input port for receiving the Ethernet signal, and an Ethernet output port configured to output an Ethernet portion of the composite Ethernet/DC power signal to a non-PoE Ethernet device.

16. The system of claim 10, wherein the Ethernet PoE device further comprises a power input for receiving DC power.

17. The system of claim 10, wherein the Ethernet PoE device further comprises a power on/off switch configured to turn on or off the power in the composite Ethernet and power signal supplied to the PoE powered device.

18. An Ethernet PoE (“Power over Ethernet”) device for providing a composite Ethernet/DC power signal to a PoE device regardless of Ethernet connection availability to the PoE device, comprising:
a composite Ethernet/DC power signal generator configured to receive an Ethernet signal from a source and to receive a DC power signal at a coaxial cable input port, generate a composite Ethernet/DC power signal based on the received Ethernet signal and the DC power signal, and output the composite Ethernet/DC power signal to an Ethernet output port;
wherein Ethernet PoE device is configured to output the composite Ethernet/DC power signal to the PoE device through an Ethernet cable connected to the Ethernet output port regardless of Ethernet connection availability to the PoE device; and
wherein the DC power signal is configured to power the PoE device.

19. The device of claim 18, wherein the DC power signal is within a range of 40 VDC to 57 VDC.

20. The device of claim 18, wherein the composite Ethernet/DC power signal includes an RF signal for being routed by the PoE device to an RF device.

21. The device of claim 18, further comprising an Ethernet output port configured to send an Ethernet portion of the composite Ethernet/DC power signal to a non-PoE Ethernet device.

22. The device of claim 18, wherein the DC power signal comprises a 48 VDC signal.

23. The device of claim 18, further comprising a power on/off switch configured to turn on or off the power in the composite Ethernet/DC power signal supplied to the PoE device.

24. The device of claim 18, wherein the DC power signal is configured to power the PoE device so that the PoE device does not have to be connected to a power wall outlet and the Ethernet signal is received by the PoE device so that the PoE device does not have to be connected to an Ethernet wall outlet.

25. The device of claim 18, wherein the Ethernet PoE device further comprises a power input for receiving DC power.
